(19) United States
(12) Patent Application Publication
(10) Pub. No.: US 2003/0074723 A1
(43) Pub. Date: Apr. 24, 2003

(54) Inflatable cushion

(76) Inventors: Uwe Bücken, Pulheim (DE); Gunter Pütz, Koln (DE)

Correspondence Address: Fish & Richardson, 225 Franklin Street, Boston, MA, 02110-2804, US

(21) Appl. No.: 10/069,326

(22) PCT Filed: Jun. 20, 2001
(86) PCT No.: PCT/DE01/02252

(30) Foreign Application Priority Data
Jun. 20, 2000 (DE) 200 10 921.9

(51) Int. Cl. A41D 1/00; F41H 1/00; G21F 3/02; A62B 17/00

(52) U.S. Cl. 2/455

(57) ABSTRACT

The invention relates to an inflatable cushion comprising at least two interconnected films, one of which forms the underside of the cushion and the other film has elastomeric properties and forms the upper face of the cushion. When inflated, said cushion has a width (B) ranging between 50 and 80 cm, a length (L) of between 10 and 30 cm and a height (H) of a maximum 10 cm. The cushion comprises a substantially flat underside (1), a respective convex upper face (2) and (2a) in both border areas, when viewed from the longitudinal cross-section and at least one depression (3) in the upper face, which lies between the border areas and is concave towards the underside. The invention also relates to the use of said cushion as an anatomically pre-formed cushion, in particular for the orthopaedic, preventive and post-operative treatment of complaints of the vertebral column, shoulders and/or the knee-joint.

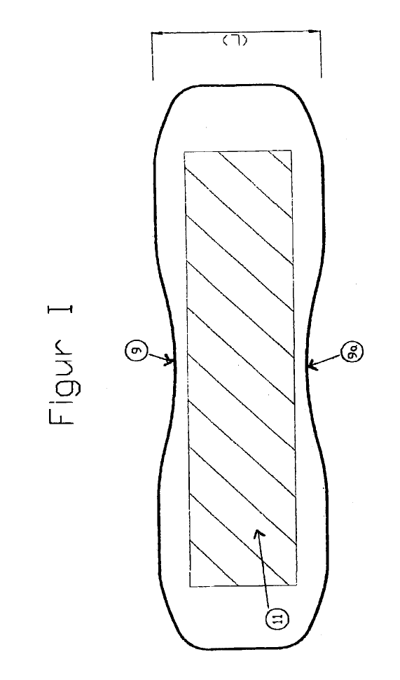

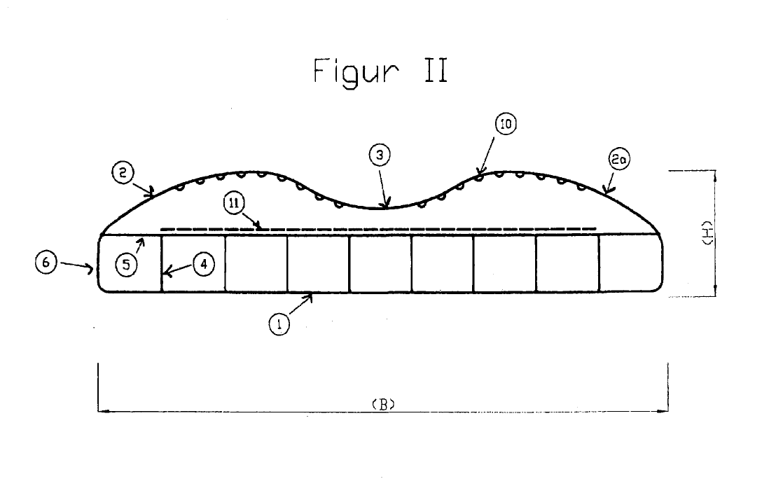

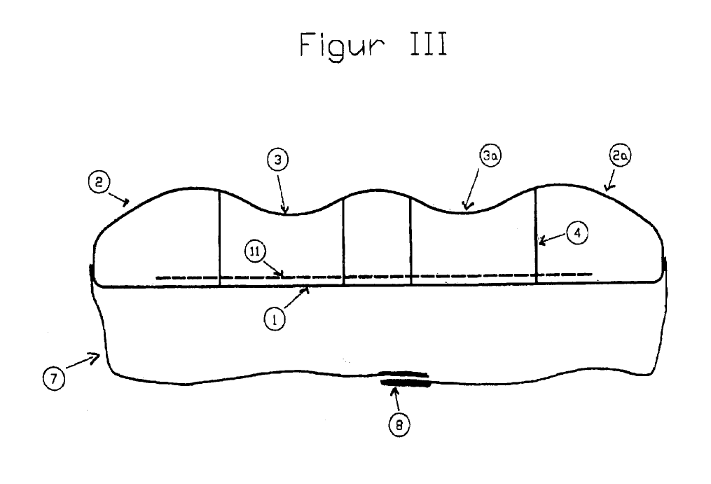

The present invention relates to the field of inflatable cushions and more particularly to their use in the field of orthopaedic and post operative treatments.

Inflatable cushions are well known. Generally, they are advantageous because they are easy to transport when not inflated using not much space and the pneumatic bolstering serves to distribute the body weight evenly over the several parts of the body.

A medical cushion that diminishes pain caused by pressure sensitivity of parts of the skeleton muscles because of its elastic pressure distributing material is described in the DE-OS 39 12 709 A1, for example.

Although the cushion comprises anatomically formed omissions corresponding to some parts of the body the surface of the cushion is essentially flat. Therefore, the necessary pressure relief is only reached by counter action of the body weight and the bulk modulus of the elastic material.

DE-OS 33 00 851 A1 relates to a support for car seats. Its pneumatic part relating to the lower spine comprises of uneven deformations and elasticity. The support further comprises of a rigid frame so that a too big bending is prevented.

In regard to the physiotherapeutic features of the cushion the massage function is essential, especially when long distance drives are concerned, but there is no real pressure relief for the spine which is of primary concern especially in orthopaedic diseases of the cervical spine.

Object of the present invention is to provide an inflatable cushion being essentially helpful in the treatment of the cervical spine, shoulder and/or knee because of its form and pressure releasing properties.

It is important that the cushion can be adjusted to the anatomically properties of the cervical spine, the shoulder and/or the knee without influencing the orthopaedic essential supporting function of the cushion.

This object is achieved according to the present invention by an inflatable cushion comprising of at least two joint foils wherein one of the foils forms the underside of the cushion and the other foil having elastomeric properties forms the top face of the cushion being between 50 and 80 cm wide, between 10 and 30 cm long and 10 cm at max. high when inflated and comprising of an essentially flat underside (1) and in the cross view along the longitudinal axis on both edges convex arched top face (2) and (2a) and at least one in direction of the underside concave shaped trough (3) between the edges of the top face.

One essential feature of the present invention is that the concave dent builds a pre-forming for the corresponding parts of the body and that the necessary anatomical adaptation is provided by the elastomeric properties of the foil building the top-face of the cushion.

Therefore, the otherwise unpreventable pressure points in the area of the rear head and of the rear neck and shoulder or in the area of the ischiocrural muscles or calf are prevented.

Apart from the relaxation of the muscles of the cervical spine and of the trapezius muscles or the ischiocrural muscles and of the muscles of the lower leg, compression of arteries and veins, metabolic congestion, lymphostatics, sensory disturbance or nerve stimulation are inhibited and optimal postural of the corresponding articular capsules is provided.

An optimal adaptation of the present invention to the anatomic details in combination with adequate supporting properties can be acquired by a simple test. The test shows a sufficient pressure relief if a cylindrical roll with a diameter of 12 cm, a length of 15 cm and a weight of 8 kg is put into the trough (3) of the inflatable cushion and the trough (3) is lowered more than 1 cm by the weight.

A sufficient support of the cushion is indicated when a side power of 10 N in axial direction is put upon the cylindrical roll without lifting the roll out of the trough. This test can be easily carried out by fixing a bracket on both sides of the roll such that it is hinged to the middle axis and the centre of the bracket is linked to a weight of 1 kg hanging freely on a wire that runs via a deflection pulley.

In another embodiment of the present invention the cushion further comprises at least one centre bridge (4) running in longitudinal direction of the cushion and being linked with the underside and the top-face of the cushion. Like that, the underside of the cushion remains essentially flat when the cushion is inflated.

According to an especially preferred embodiment the cushion of the present invention further comprises an intermediate foil (5) between the underside and the top face which edges are directly linked with the edges of the top face and which is linked with the underside via cross-bar (6) running along the edges of the cushion.

This cushion with this intermediate foil (5) can additionally comprise of at least one centre bridge (4) running in longitudinal direction and being linked with the under side via an intermediate foil. Depending upon the elasticity of the foil material it can be necessary to include several centre bridges wherein the distances between the centre bridges do not have to be equidistant.

Like that, the centre bridges serve in a very efficient way to prevent the underside (1) of the cushion from being heavily bent and therefore acquire the supporting function of the trough (3) which is very important from the orthopaedic point of view.

If the cushion further comprises of at least one cross-bar and/or centre bridge the chambers built by the cross-bar and/or the centre bridge can be linked by internal openings with each other. Therefore, it is possible to build a cushion that comprises only one intake valve which makes the handling of the cushion much more comfortable.

In another embodiment of the present invention the cushion further comprises a fixation means (7) to surround a seat or bed. This fixation means serves to fix the cushion to a seat or medical bed like a massage bench. The fixation means (7) can comprise an elastic area and a fastening (8) being freely loosenable like it is shown in FIG. III.

If the fixation means has to be fastened and unfastened very often the fastener (8) is preferably a Velcro fastener.

Apart from that, a towel can be placed between the cushion and the seat and/or bed which is important especially in hygienic aspects of the use of the present invention.

According to another preferred embodiment of the present invention the cushion comprises two troughs running in longitudinal direction (3) and (3a). Such a cushion is shown in FIG. III, for example. It is used especially for orthopaedic treatment of diseases in the area of the knee.

A special embodiment of the present invention relates to a cushion further comprising at least one dent (9) directed to the internal of the cushion and especially comprising two dents (9) and (9a) located on both sides of the cushion which form the width of the cushion.

An embodiment like that is chosen when the orthopaedic use of the cushion is directed to the relief of the corresponding pressure points of the neck (occiput and shoulder girdle) or of the knee (calf muscles and ischiocrural muscles). Furthermore, sensitivity disturbances and motoricity failures of the arm and shoulder area can be effectively prevented by incorporation of such troughs.

The foils used for the cushion according to the present invention are made of an elastic and/or thermoplastic material, preferably of latex or PVC.

Therefore, an optimal anatomical adaptation to the corresponding parts of the body is acquired.

The top face of the cushion can have reinforcements and/or rims in the area of the omissions to profile the surface contour.

Place, shape and direction of the reinforcements and/or rims is dependant upon the desired pre-forming.

If the cushion shall give an essentially sideward support the rimes and/or reinforcements (10) run in longitudinal direction of the cushion and are preferably jig welded.

Moreover, the foils used for the cushion of the present invention can consist of a transparent, and preferably of a lucid material.

Such a cushion can comprise of an underside or of an intermediate foil comprising an advertising print (11) directed to the inside of the cushion.

Like that it is possible to place an advertisement very effectively that can be seen through the top face of the cushion.

By the choice of a material being less elastic for the underside or the intermediate foil of the cushion distortions of the print can be generally excluded.

Furthermore, the cushion can be between 65 and 70 cm wide, between 18 and 20 cm long, and between 6 and 8 cm high.

This size makes the cushion universally applicable for the most common orthopaedic treatments.

It is a further object of the cushion according to the preceding description to be preferably used as an anatomically pre-formed cushion especially for orthopaedic and post operative treatment of diseases of the cervical spine, the shoulder and/or the knee.

FIGS. I to III serve to clarify some of the possible embodiments.

FIG. I is a top view and FIG. II is a section along the width of the cushion according to the present invention with a trough (3), an intermediate foil (5) being positioned between the underside (1) and the top face, a cross-bar (6) building the edge of the cushion and several centre bridges stabilizing the cushion on a flat surface.

FIG. III is a section along the width of the cushion according to the present invention with two troughs (3) and (3a) without an intermediate foil but with a fixation (7) having a fastener (8).

In FIGS. I to II the following references are used (in numerical order):

| | |
|---|---|
| (1) | underside |
| (2) and (2a) | convex shaped top face |
| (3) and (3a) | concave trough |
| (4) | centre bridge |
| (5) | intermediate foil |
| (6) | cross-bar |
| (7) | fixation means |
| (8) | fastener |
| (9) | dent |
| (10) | reinforcements/rims |
| (11) | advertisement print |

1. Inflatable cushion comprising of at least two joint foils wherein one of the foils forms the underside of the cushion and the other foil having elastomaric properties forms the top face of the cushion being between 50 and 80 cm wide, between 10 and 30 cm long and 10 cm at max. high when inflated and comprising of an essentially flat underside (1) and in the cross view along the longitudinal axis on both edges convex arched top face (2) and (2a) and at least one in direction of the underside concave shaped trough (3) between the edges of the top face.

2. Cushion according to claim 1 characterised in that the cushion has additionally at least one centre bridge in the longitudinal direction being linked with the underside and the top face of the cushion.

3. Cushion according to claim 1 characterised in that the cushion has additionally an intermediate foil (5) between the underside and the top face which edges are directly linked with the edges of the top face and which is linked with the underside via cross-bar running along the edges of the cushion.

4. Cushion according to claim 3 characterised in that the cushion additionally comprises of at least one centre bridge (4) running in longitudinal direction and being linked with the under side via an intermediate foil.

5. Cushion according to claims 4 or 5 characterised in that the chambers built by the cross-bar and/or the centre bridge are linked by internal openings with each other.

6. Cushion according to claim 5 characterised in that it comprises only one intake valve.

7. Cushion according to one of the preceding claims characterised in that the cushion additionally comprises a fixation (7) to surround a seat or bed.

8. Cushion according to claim 7 characterised in that the fixation (7) comprises an elastic area and a fastening (8) being freely loosenable.

9. Cushion according to claim 8 characterised in that the fastening (8) is a Velcro fastener.

10. Cushion according to one of the preceding claims characterised in that the cushion comprises two troughs running in longitudinal direction (3) and (3a).

11. Cushion according to one of the preceding claims characterised in that the cushion comprises at least one dent (9) directed to the internal of the cushion.

12. Cushion according to claim 11 characterised in that the cushion comprises of dents (9) located on both sides of the cushion which form the width of the cushion.

13. Cushion according to one of the preceding claims characterised in that the foils are made of an elastic and/or thermoplastic material, preferably of latex or PVC.

14. Cushion according to one of the preceding claims characterised in that the top face having reinforcements and/or rims in the area of the omissions to profile the surface contour.

15. Cushion according to claim 14 characterised in the rimes and/or reinforcements (10) run in longitudinal direction of the cushion and are preferably jig welded.

16. Cushion according to one of the preceding claims characterised in that the foils consist of a transparent preferably of a lucid material.

17. Cushion according to claim 16 characterised in that underside or the intermediate foil comprise an advertising print (11) on the inside of the cushion.

18. Cushion according to one of the preceding claims characterised in that the cushion is between 65 and 70 cm wide, between 18 and 20 cm long, and between 6 and 8 cm high.

19. Use of the cushion according to one of the preceding claims as an anatomically formed cushion especially for orthopaedic, preventive and post operative treatment of spine diseases and/or of diseases of the shoulder and/or of the knee.
